(19) United States
(12) Patent Application Publication
(10) Pub. No.: US 2019/0126368 A1
(43) Pub. Date: May 2, 2019

(54) SINGLE-BLADE-DOUBLE-EDGED STEEL WIRE ROPE SHEARS

(71) Applicant: NUSHARP INC., TAICHUNG (TW)

(72) Inventors: SUNG-YU CHANG, TAICHUNG (TW); CHUN-CHIEH LIAO, TAICHUNG (TW)

(21) Appl. No.: 16/232,019

(22) Filed: Dec. 25, 2018

Related U.S. Application Data
(63) Continuation-in-part of application No. 15/638,272, filed on Jun. 29, 2017.

(30) Foreign Application Priority Data
Oct. 19, 2016 (TW) 105215888

(51) Int. Cl. B23D 29/02; B23D 35/00; B23D 29/00

(52) U.S. Cl. CPC B23D 29/023; B23D 29/002; B23D 35/001

(57) ABSTRACT

A pair of single-blade-double-edged steel wire rope shears, includes: a first cutting member and a second cutting member pivotally connected to each other. The first cutting member includes a first grip and a first blade, the first blade includes a first lateral cutting edge and a first bottom cutting edge; the second cutting member includes a second grip and a second blade, the second blade includes a second lateral cutting edge and a second bottom cutting edge; when the first and second grips pivot toward each other, the first and second lateral cutting edges cut a to-be-cut object inserted therebeween, meanwhile, the first and second bottom cutting edges also cut the to-be-cut object, so as to form at least three cutting points on the to-be-cut object, and as a result, the pair of single-blade-double-edged steel wire rope shears can improve cutting efficiency.

### CROSS REFERENCE TO RELATED APPLICATION

This application is a continuation in part of U.S. patent application Ser. No. 15/638,272, which claims the earlier filing date of Jun. 29, 2017, the entire specification of which is incorporated herein by reference.

### BACKGROUND

### Field of the Invention

The present invention relates to a device for cutting steel wire ropes, and more particularly to a pair of single-blade-double-edged steel wire rope shears.

### Related Prior Art

A pair of conventional steel wire rope shears 100A disclosed in Taiwan Patent No. M459957 is shown in FIGS. 1A and 1B, and includes a left rod 1A, a right rod 2A, a jaw 11A at the top end of the left rod 1A, and a jaw 21A at the top end of the right rod 2A. The jaws 11A and 21A cooperate with each other to cut the object (such as a steel wire rope) to be cut.

Another pair of conventional steel wire rope shears 200B disclosed in Taiwan Patent No. M427723 is shown in FIGS. 2A and 2B, and includes a first blade member 10B and a second blade member 20B. The first blade member 10B includes a first shaft 11B and a first handle 12B, and the first shaft 11B includes a first blade portion 111B. The second blade member 20B includes a second shaft 21B and a second handle 22B, and the second shaft 21B includes a second blade portion 211B which cooperates with the first blade portion 111B to cut the object (such as a steel wire rope).

Each of the pairs of the steel wire rope shears 100A and 200B is provided with two jaws 11A, 21A, 11B and 21B (as shown in FIGS. 1A and 2A) or two blade portions 111B and 211B (as shown in FIGS. 2A and 2B) to bite or cut the object to be cut from both sides. For example, as shown in FIG. 1B, the two jaws 11A and 21A create two cutting points NA and P2A on the object 30A to be cut, and as shown in FIG. 2B, the first and second blade portions 111B and 211B also create two cutting points P1B and P2B on the object 30B to be cut, which makes it inconvenient for the user to apply force.

The present invention has arisen to mitigate and/or obviate the afore-described disadvantages.

### SUMMARY

One objective of the present invention is to provide a pair of single-blade-double-edged steel wire rope shears capable of providing at least three cutting points in total, and as a result, the present invention can save 8-13% of cutting force, as compared with the conventional steel wire rope shears with two cutting points.

To achieve the above objective, a pair of single-blade-double-edged steel wire rope shears in accordance with the present invention comprises: a first cutting member and a second cutting member pivotally connected to each other by a pivot member, characterized in that:

the first cutting member includes a first grip and a first blade, the first blade is provided at one side of the first cutting member facing the second cutting member with a first cutting portion, the first cutting portion includes a first lateral cutting surface, a first lateral cutting edge, a first bottom cutting surface, and a first bottom cutting edge, the first bottom cutting edge is connected to the first bottom cutting surface, the first bottom cutting surface is inclined, the first lateral cutting edge is connected to the first lateral cutting surface, and the first lateral cutting surface is inclined;

the second cutting member includes a second grip and a second blade, the second blade is provided at one side of the second cutting member facing the first cutting member with a second cutting portion, the second cutting portion includes a second lateral cutting surface, a second lateral cutting edge a second bottom cutting surface and a second bottom cutting edge, the second bottom cutting surface is inclined and connected to the second bottom cutting edge, the second lateral cutting edge is connected to the second lateral cutting surface, and the second lateral cutting surface is inclined;

a first angle is defined between the first lateral cutting edge and the first bottom cutting edge, a second angle is defined between the second lateral cutting edge and the second bottom cutting edge, and the first and second angles are between 75 and 90 degrees;

when the first and second grips pivot toward each other, the first lateral cutting edge and the second lateral cutting edge cut a to-be-cut object which is inserted between the first and second lateral cutting edges, meanwhile, the first bottom cutting edge and the second bottom cutting edge also cut the to-be-cut object.

Preferably, wherein one surface of the first blade connected to the first bottom cutting edge is defined as a first lateral surface, one surface of the second blade connected to the second bottom cutting edge is defined as a second lateral surface, both the first lateral surface and the second lateral surface extend along the extending direction of an axis of the pivot member, an angle between the first lateral surface and the first bottom cutting surface is defined as a first inclination angle, an angle between the second lateral surface and the second bottom cutting surface is defined as a second inclination angle, and the first and second inclination angles are less than 90 degrees.

Preferably, a transverse direction, the first bottom cutting edge extends along the transverse direction, a surface of the first blade connected to the first lateral cutting edge is defined as a third lateral surface, a surface of the second blade connected to the second lateral cutting edge is defined as a fourth lateral surface, the third lateral surface and the fourth lateral surface all extend along the transverse direction, an angle defined between the third lateral surface and the first lateral cutting surface is defined as a third inclination angle, an angle between the fourth lateral surface and the second lateral cutting surface is defined as a fourth inclination angle, and the third and fourth inclination angles are less than 90 degrees.

Preferably, wherein the first bottom cutting edge extends along a transverse direction which is perpendicular to an axis of the pivot member, and when the first and second cutting members are opened, the axis separates the first lateral cutting edge and the second lateral cutting edge from each other at two different sides of a plane defined by the transverse direction and the axis.

Preferably, the first bottom cutting edge extends along a transverse direction which is perpendicular to an axis of the pivot member, and when the first and second cutting members are opened, the axis makes the first lateral cutting edge and the second lateral cutting edge located at a same side of a plane defined by along the transverse direction and the axis.

Preferably, the first lateral cutting surface is disconnected from the first bottom cutting surface, the second lateral cutting surface is disconnected from the second bottom cutting surface, the first lateral cutting edge is disconnected from the first bottom cutting edge, and the second lateral cutting edge is disconnected from the second bottom cutting edge.

Preferably, a groove is defined between the first lateral cutting surface and the first bottom cutting surface, the groove is also defined between the first lateral cutting edge and the first bottom cutting edge, and a groove is defined between the second lateral cutting surface and the second bottom cutting surface, the groove is also defined between the second lateral cutting edge and the second bottom cutting edge.

Preferably, a first clamping angle is defined between an imaginary extension line of the first lateral cutting edge and an imaginary extension line of the first bottom cutting edge, and a second clamping angle defined between an imaginary extension line of the second lateral cutting edge and the second bottom cutting edge, and the first clamping angle and the second clamping angle are between 75 and 90 degrees.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

FIG. 1A shows a part of a pair of steel wire rope shears disclosed in Taiwan Patent No. M459957;

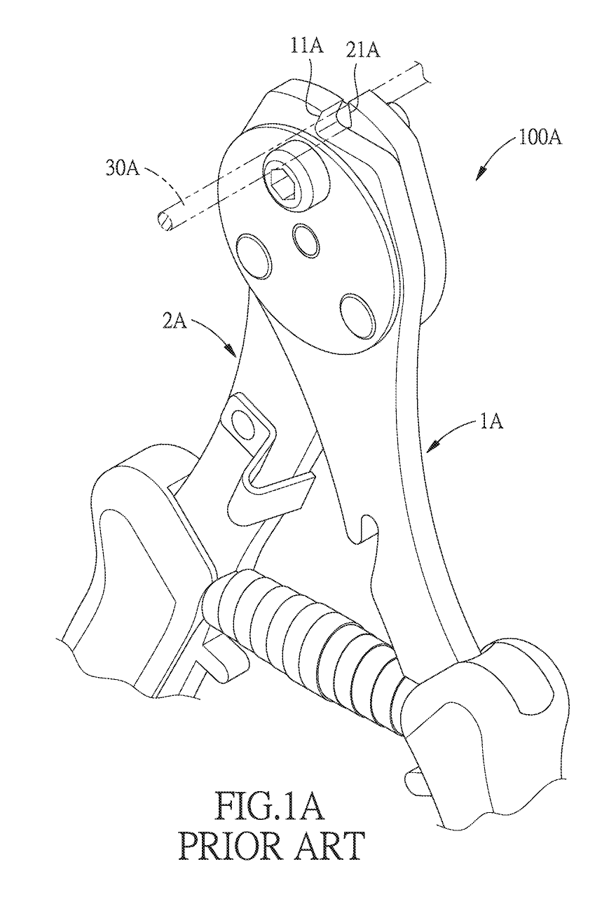

FIG. 1B is an enlarged view of a part of FIG. 1A;

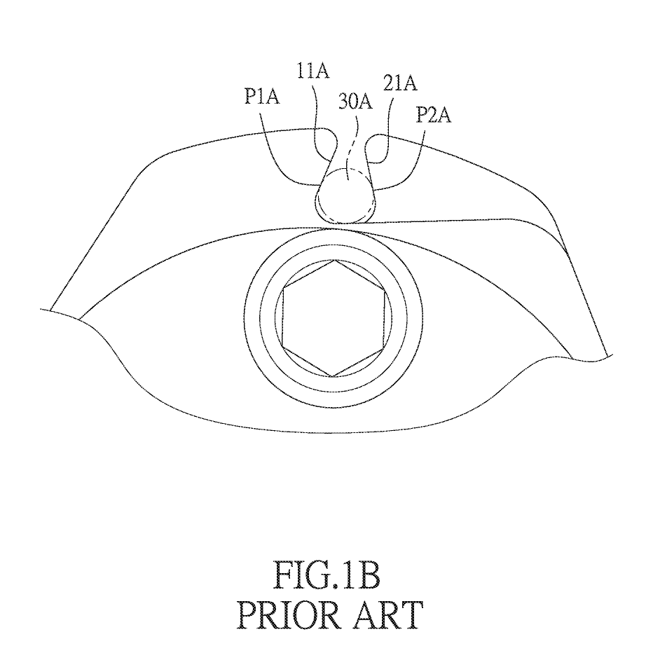

FIG. 2A shows a part of a pair of steel wire rope shears disclosed in Taiwan Patent No. M427723;

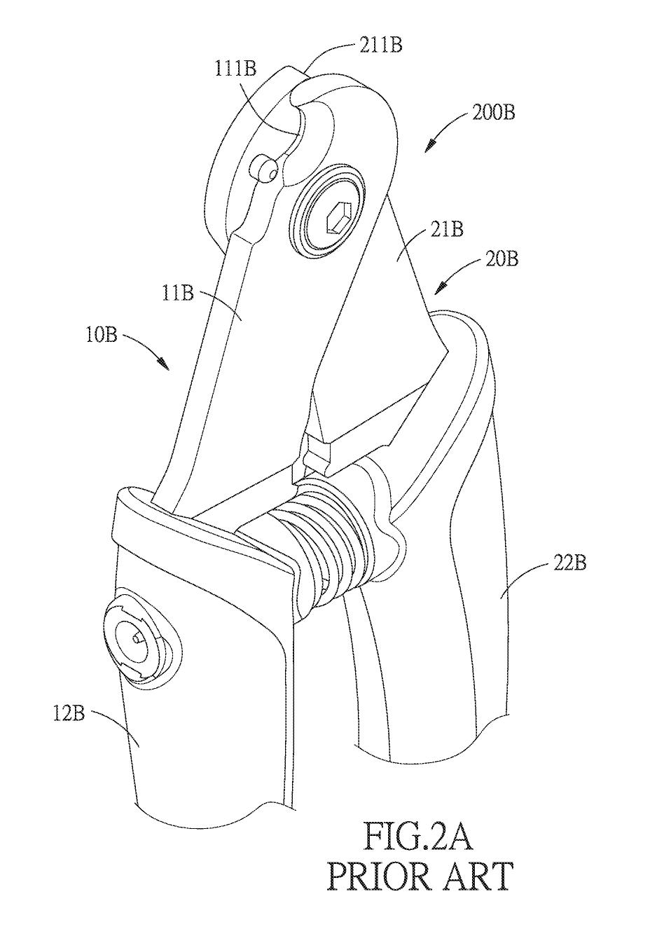

FIG. 2B is an enlarged view of a part of FIG. 2A;

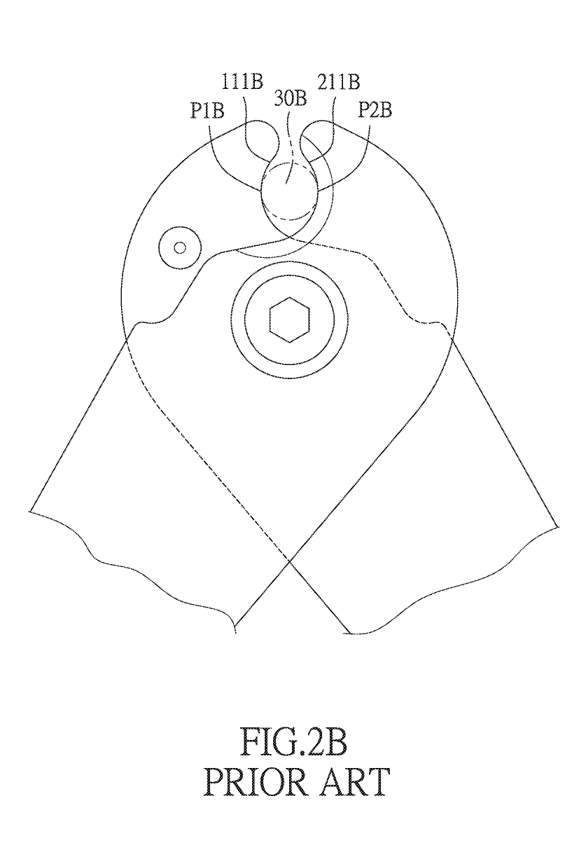

FIG. 3 is an exploded view of the pair of single-blade-double-edged steel wire rope shears in accordance with a preferred embodiment of the present invention;

FIG. 4 is a perspective view of a part of the pair of single-blade-double-edged steel wire rope shears in accordance with the preferred embodiment of the present invention;

FIG. 5A is a plan view showing a prior-to-cutting state of the pair of single-blade-double-edged steel wire rope shears of the present invention;

FIG. 5B is a plan view showing a prior-to-cutting state of the pair of single-blade-double-edged steel wire rope shears of the present invention;

FIG. 6 is a plan view showing an after-cutting state of the pair of single-blade-double-edged steel wire rope shears of the present invention;

FIG. 7 is a cross sectional view of FIG. 4;

FIG. 8 is a top view of the pair of single-blade-double-edged steel wire rope shears of the present invention;

FIG. 9 is a plan view of a pair of single-blade-double-edged steel wire rope shears in accordance with another embodiment of the present invention;

FIG. 10 is a perspective view of the pair of single-blade-double-edged steel wire rope shears in accordance with another embodiment of the present invention; and

FIG. 11 is a plan view of the pair of single-blade-double-edged steel wire rope shears in accordance with another embodiment of the present invention.

### DETAILED DESCRIPTION

The present invention will be clearer from the following description when viewed together with the accompanying drawings, which show, for purpose of illustrations only, the preferred embodiment in accordance with the present invention.

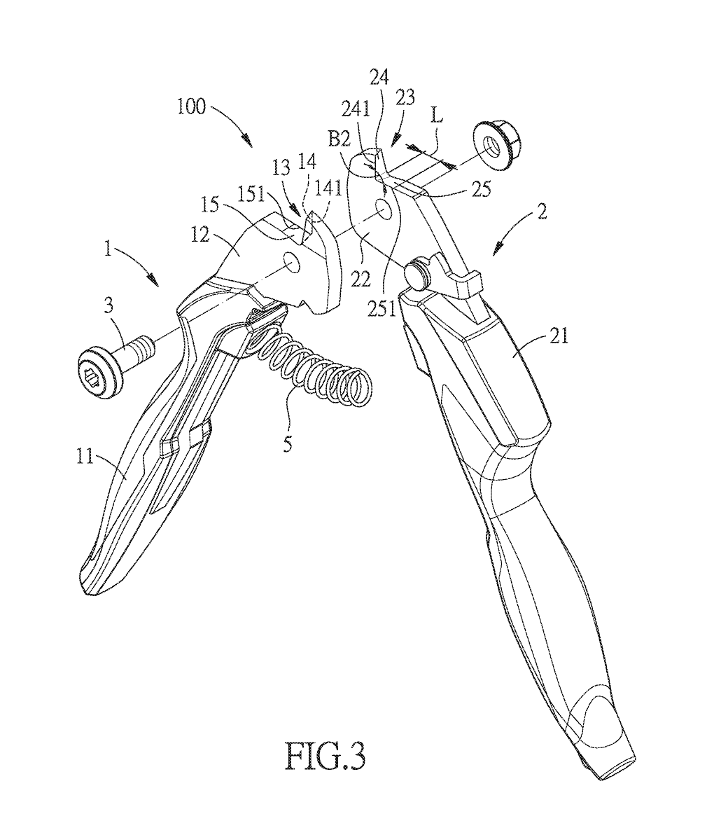

Referring to FIGS. 3-8, the pair of single-blade-double-edged steel wire rope shears 100 in accordance with a preferred embodiment of the present invention, includes: a first cutting member 1 and a second cutting member 2 which are pivotally connected to each other by a pivot member 3 (such as a pin).

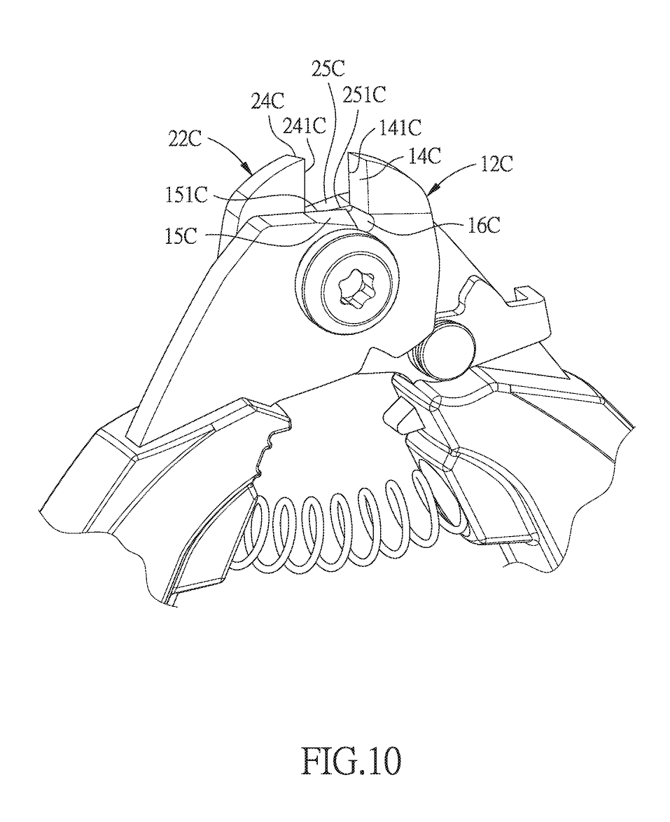

The first cutting member 1 includes a first grip 11 and a first blade 12. The first blade 12 is provided at one side thereof facing the second cutting member 2 with a first cutting portion 13, and the first cutting portion 13 includes a first lateral cutting surface 14, a first lateral cutting edge 141, a first bottom cutting surface 15 and a first bottom cutting edge 151. The first bottom cutting edge 151 is connected to the first bottom cutting surface 15, the first bottom cutting surface 15 is inclined, the first lateral cutting edge 141 is connected to the first lateral cutting surface 14, and the first lateral cutting surface 14 is inclined. In a specific embodiment, the first bottom cutting edge 151 is a cutting edge located at one side of the first bottom cutting surface 15, and the first lateral cutting edge 141 is a cutting edge located one side of the first lateral cutting surface 14. The first lateral cutting surface 14 connected with the first bottom cutting surface 15. As shown in FIG. 10, 11, in another embodiment, a groove 16C is defined between the first lateral cutting surface 14C and the first bottom cutting surface 15C, so that the first lateral cutting surface 14C is disconnected from the first bottom cutting surface 15C, and the first lateral cutting edge 141C is disconnected from the first bottom cutting edge 151C.

The second cutting member 2 includes a second grip 21 and a second blade 22. The second blade 22 is provided at one side thereof facing the first cutting portion 13 of the first cutting member 1 with a second cutting portion 23. The second cutting portion 23 includes a second lateral cutting surface 24, a second lateral cutting edge 241, a second bottom cutting surface 25, and a second bottom cutting edge 251. The second bottom cutting edge 251 is inclined and connected to the second bottom cutting surface 25. The second lateral cutting edge 241 is connected to the second lateral cutting surface 24, and the second lateral cutting surface 24 is inclined. In a specific embodiment, the second bottom cutting edge 251 is a cutting edge located at one side of the second bottom cutting surface 25, and the second lateral cutting edge 241 is a cutting edge located one side of the second lateral cutting surface 24. The second lateral cutting surface 24 connected with the second bottom cutting surface 25. As shown in FIG. 10, a groove can also be defined between the second lateral cutting surface 24C and the second bottom cutting surface 25C, so that the second lateral cutting surface 24C is disconnected from the second bottom cutting surface 25C, the second lateral cutting edge 241C is disconnected from the second bottom cutting edge 251C, and the first cutting portion 13 and the second cutting portion 23 can define a roughly U-shaped cutting gap before performing cutting operation.

An elastic member 5 is connected between the first and second grips 11, 21, so that the first and second grips 11, 21 can be returned to their original positions after cutting operation.

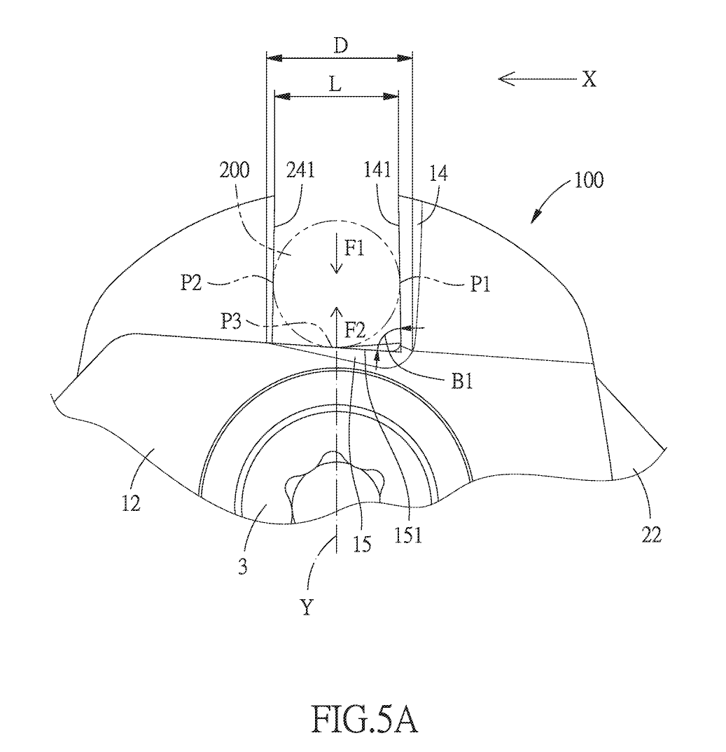

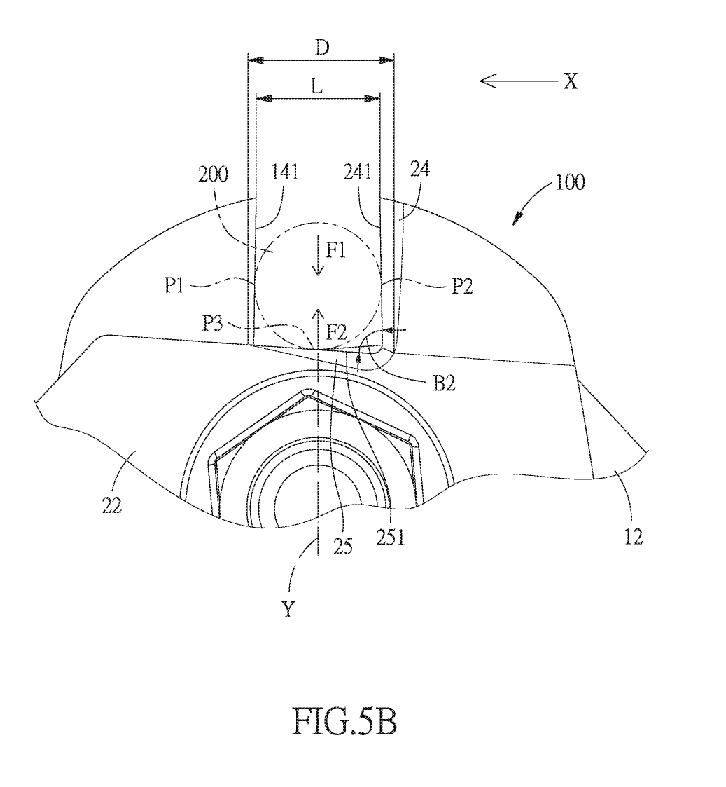

Referring to FIGS. 5A and 5B, the first lateral cutting edge 141 and the first bottom cutting edge 151 define a first angle B1 of 75 to 90 degrees therebetween, the second lateral cutting edge 241 and the second bottom cutting edge 251 define a second angle B2 of 75 to 90 degrees therebetween, and the first angle B1 is equal to the second angle B2. The first lateral cutting edge 141, the first bottom cutting edge 151, the second lateral cutting edge 241, and the second bottom cutting edge 251 all extend along a straight line.

As further shown in FIG. 5A, the first bottom cutting edge 151 extends along a transverse direction X which is perpendicular to an axis Y of the pivot member 3, and when the first and second cutting members 1, 2 are opened, the axis Y separates the first lateral cutting edge 141 and the second lateral cutting edge 241 from each other at two different sides of a plane defined by the transverse direction X and the axis Y.

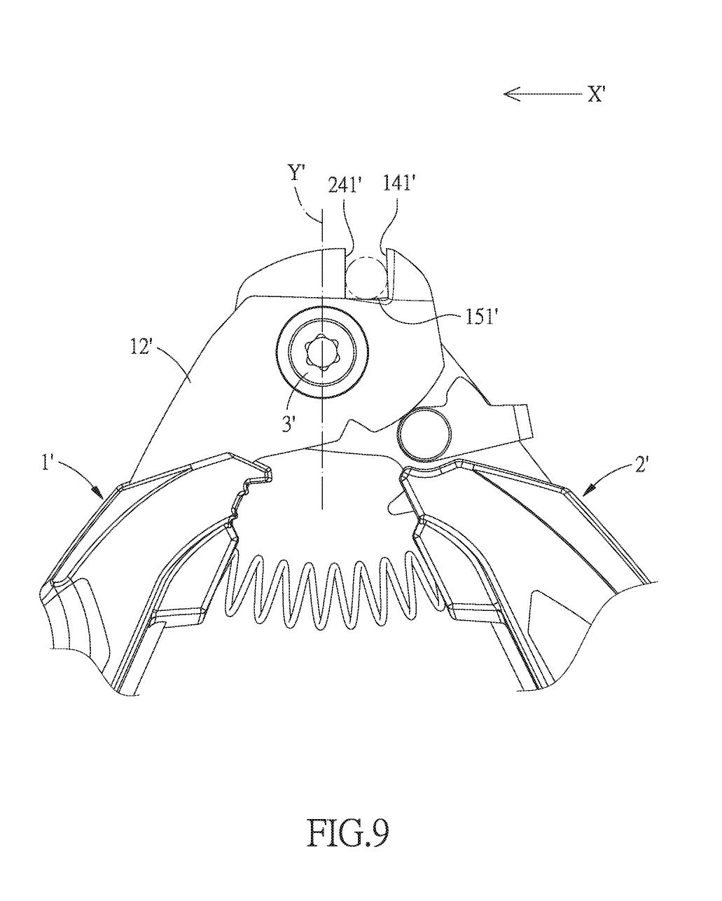

As shown in FIG. 9, in another embodiment of the invention, the first bottom cutting edge 151′ extends along a transverse direction X,the pivot member 3′ includes an axis Y′ which is perpendicular to a transverse direction X′, and the axis Y′ makes the first lateral cutting edge 141′ and the second lateral cutting edge 241′ located at the same side of a plane defined by the transverse direction X′ and the axis Y′.

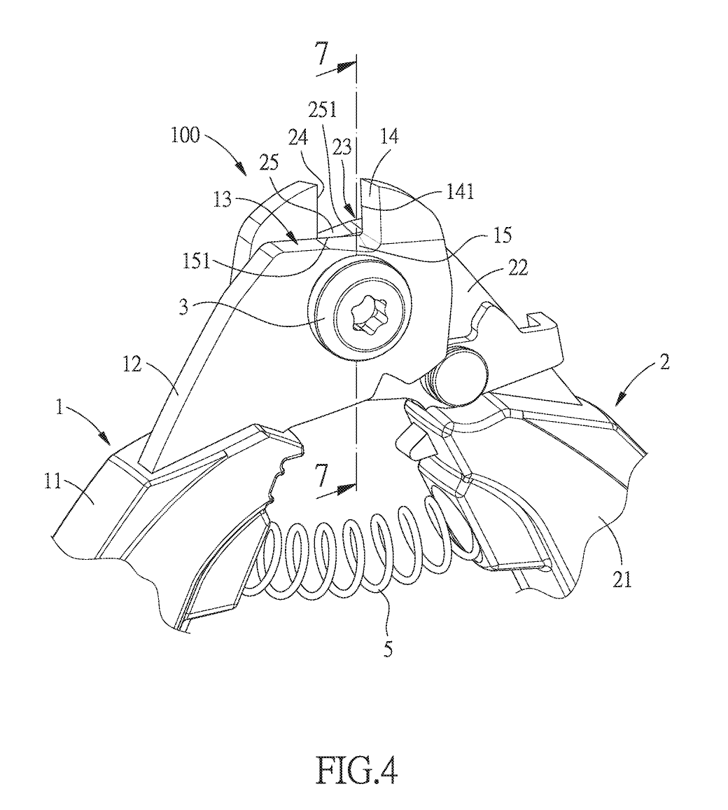

Referring then to FIGS. 4-6 again, when the first and second grips 11, 21 pivot toward each other, the first lateral cutting edge 141 and the second lateral cutting edge 241 can cut two opposite lateral edges of a to-be-cut object (such as a steel wire rope) 200 which is inserted in the U-shaped cutting gap, meanwhile, the first bottom cutting edge 151 and the second bottom cutting edge 251 can cut the bottom edge of the to-be-cut object 200, so as to form at least three cutting points on the to-be-cut object 200. Namely, at least three cutting points can be created when the first and second angles B1, B2 are approximately 75 degrees, which includes:

two cutting points P1 and P2 formed by the first lateral cutting edge 141 and the second lateral cutting edge 241, and at least one cutting point P3 formed by the first bottom cutting edge 151 and the second bottom cutting edge 251. When the to-be-cut object 200 has a relatively large diameter, more than two cutting points (not shown in this embodiment) will be formed at the first bottom cutting edge 151 and the second bottom cutting edge 251. When the first and second angles B1, B2 are approximately 90 degrees, about four cutting points will be formed, namely, a cutting point will be formed at each of the first lateral cutting edge 141, the second lateral cutting edge 241, the first bottom cutting edge 151 and the second bottom cutting edge 251.

Please refer to the table 1 as below, which shows the cutting strength (kgf) comparison between the pair of single-blade-double-edged steel wire rope shears 100 of the invention and the conventional steel wire rope shears (HWC6):

TABLE 1

| | Rope diameter | | | | | |
|---|---|---|---|---|---|---|
| | φ5 | | φ4 | | φ3 | |
| | type | | | | | |
| | φ0.33 × 19 × 6 | | φ0.26 × 19 × 6 | | φ0.32 × 7 × 6 | |
| | The | | The | | The | |
| sample | invention | HWC6 | invention | HWC6 | invention | HWC6 |
| 1 | 47.0 | 51.9 | 28.7 | 31.6 | 18.9 | 22.3 |
| 2 | 45.8 | 50.2 | 27.9 | 32.4 | 19.4 | 21.2 |
| 3 | 47.7 | 49.7 | 27.7 | 32.3 | 21.2 | 21.3 |
| 4 | 46.4 | 51.4 | 29.0 | 31.6 | 18.9 | 22.8 |
| 5 | 46.1 | 49.4 | 29.4 | 33.0 | 19.8 | 21.9 |
| Average | 46.6 | 50.5 | 28.5 | 32.2 | 19.6 | 21.9 |

Table 1

The average value of the above table 1 shows that the present invention saved 8% of the cutting force applied to the rope φ0.33×19×6, namely, (50.5−46.6)/46.6=0.08; saved 13% of the cutting force applied to the rope φ0.26×19×6, namely (32.2−28.5)/28.5=0.13; and saved 12% of the cutting force applied to the rope φ0.32×7×6, namely (21.9−19.6)/19.6=0.12. Namely, the pair of single-blade-double-edged steel wire rope shears 100 of the present invention can save 8-13% of cutting force, as compared with the conventional steel wire rope shears (HWC6).

In addition to the two cutting points formed by the first and second lateral cutting edges 141, 241, the first and second bottom cutting edges 151, 251 also further provide at least one cutting point, thus forming at least three cutting points in total, and as a result, the present invention can save 8-13% of cutting force, as compared with the conventional steel wire rope shears with two cutting points.

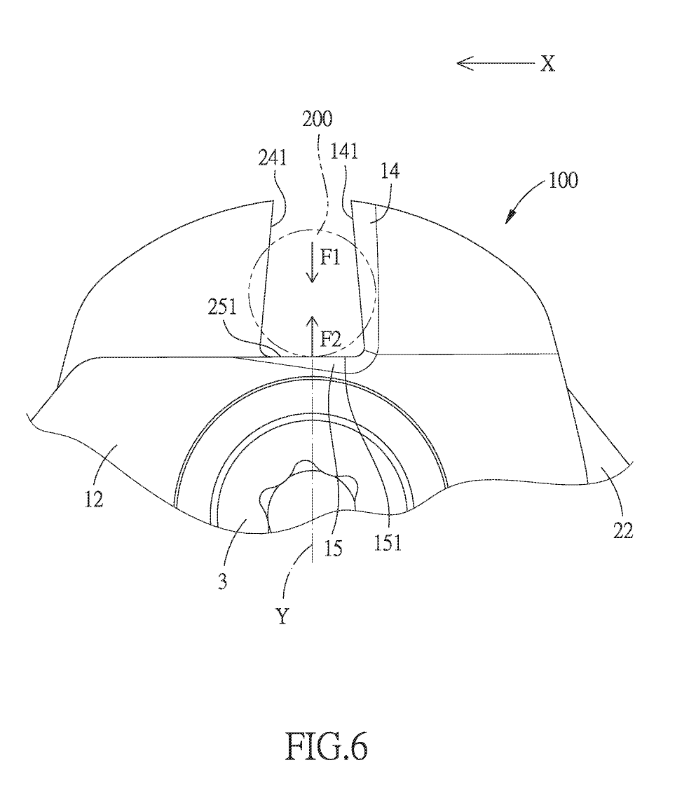

Besides, when the first and second lateral cutting edges 141, 241 pivot toward each other, as shown in FIG. 6, the tip ends of the first and second lateral cutting edges 141, 241 move close to each other rapidly, and the U-shaped cutting gap narrows gradually, the two cutting points P1, P2 on the to-be-cut object 200 will move gradually toward the upper half portion of the to-be-cut object 200 to produce a downward pressing force F1 applied to the to-be-cut object 200 to press the first and second bottom cutting edges 151, 251. Meanwhile, an upward pushing force F2 will be produced at the cutting point formed by the first and second bottom cutting edges 151, 251 to push the to-be-cut object 200 toward the first and second lateral cutting edges 141, 241, so that the to-be-cut object 200 can be reliably secured to cut by the first and second lateral cutting edges 141, 241 and the first and second bottom cutting edges 151, 251, which consequently improves the cutting efficiency.

Referring then to FIGS. 5A and 5B, when the U-shaped cutting gap reaches its maximum width, the combined length L of the parallel first and second bottom cutting edges 151, 251 is equal to or smaller than a distance D between the first and second lateral cutting surfaces 14, 24, which allows the to-be-cut object 200 to be reliably cut when placed in the U-shaped cutting gap, consequently improving the cutting efficiency.

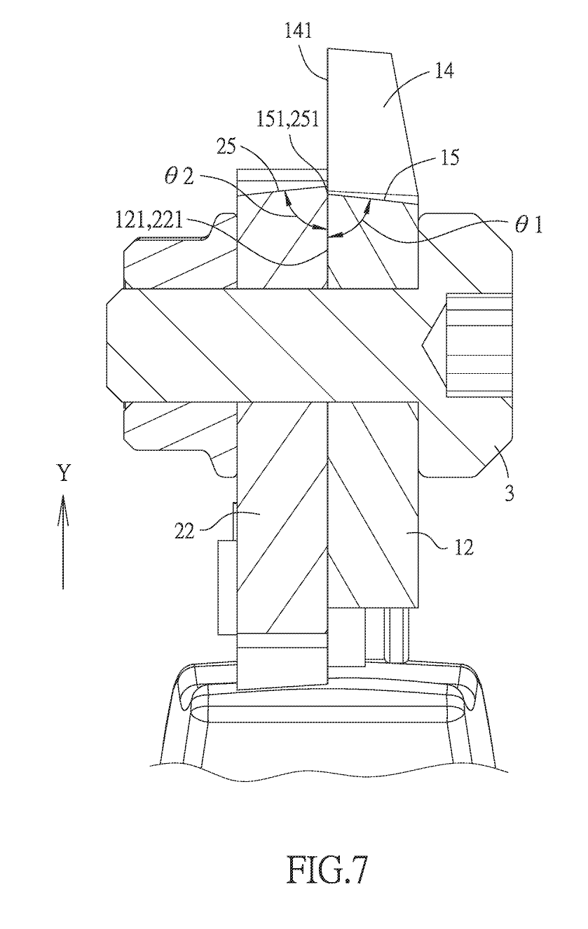

In the preferred embodiment, as shown in FIGS. 4 and 7, FIG. 7 is a cross-sectional view of FIG. 4, since the first blade 12 and the second blade 22 are of the same structure in this embodiment are of the same structure, they are all illustrated in FIG. 7. One surface of the first blade 12 connected to the first bottom cutting edge 151 is defined as a first lateral surface 121, one surface of the second blade 22 connected to the second bottom cutting edge 251 is defined as a second lateral surface 221, and both the first lateral surface 121 and the second lateral surface 221 extend along the extending direction of the axis Y. Defining an angle between the first lateral surface 121 and the first bottom cutting surface 15 as a first inclination angle θ1, and an angle between the second lateral surface 221 and the second bottom cutting surface 25 as a second inclination angle θ2, the first and second inclination angles θ1, θ2 are less than 90 degrees. Preferably, the first and second inclination angles θ1, θ2 are 75 to 89 degrees.

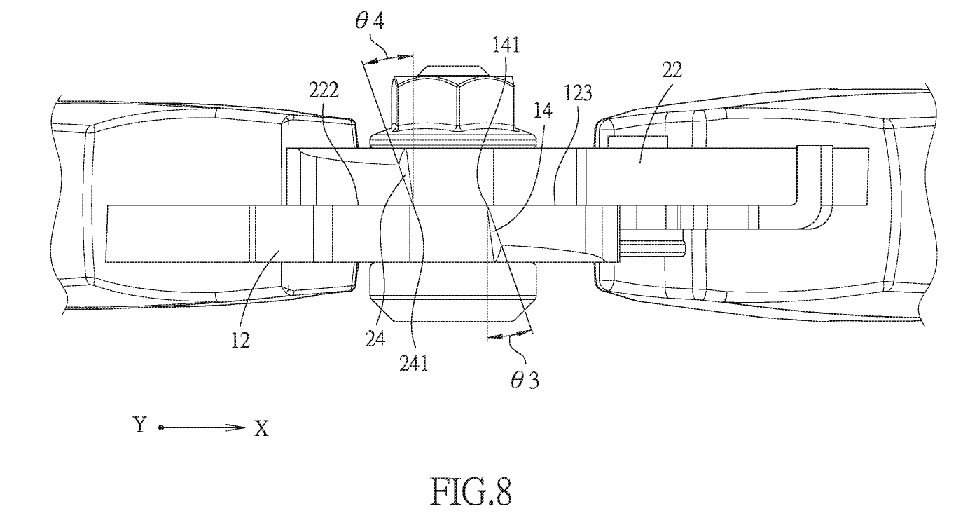

As shown in FIG. 8, since the first blade 12 and the second blade 22 in this embodiment are of the same structure, they are all illustrated in FIG. 8. A surface of the first blade 12 connected to the first lateral cutting edge 141 is defined as a third lateral surface 123, a surface of the second blade 22 connected to the second lateral cutting edge 241 is defined as a fourth lateral surface 222, and the third lateral surface 123 and the fourth lateral surface 222 all extend along the transverse direction X. An angle defined between the third lateral surface 123 and the first lateral cutting surface 14 is defined as a third inclination angle θ3, and an angle between the fourth lateral surface 222 and the second lateral cutting surface 24 is defined as a fourth inclination angle θ4. The third and fourth inclination angles θ3, θ4 are less than 90 degrees. Preferably, the third and fourth inclination angles θ3, θ4 are 75 to 89 degrees.

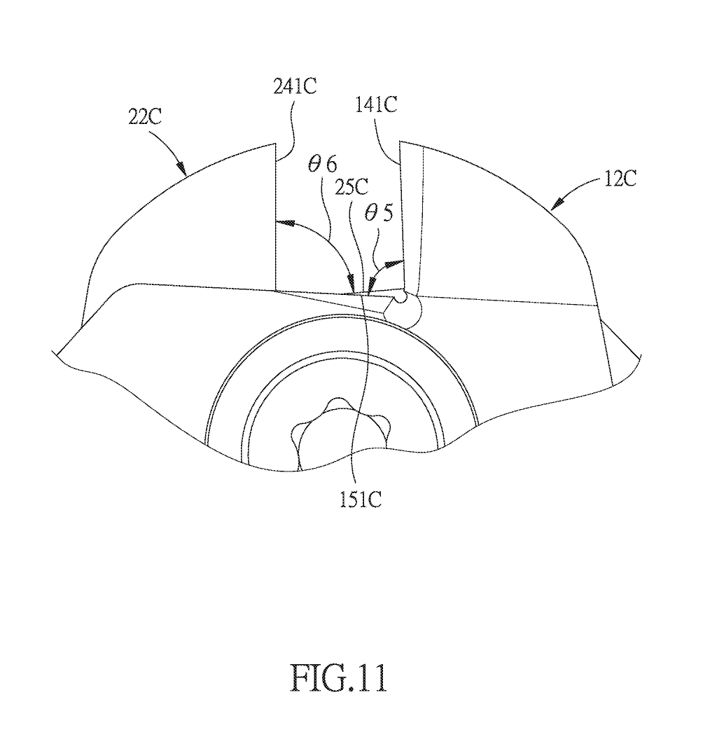

Referring then to FIG. 11, which is a lateral view of FIG. 10, since the first blade 12C and the second blade 22C in this embodiment are of the same structure, they both are illustrated in FIG. 11. In this embodiment, the first lateral cutting edge 141C is disconnected from the first bottom cutting edge 151C, the second lateral cutting edge 241C is disconnected from the second bottom cutting edge 251C, and therefore, suppose that there are a first clamping angle θ5 defined between an imaginary extension line of the first lateral cutting edge 141C and an imaginary extension line of the first bottom cutting edge 151C, and a second clamping angle θ6 defined between an imaginary extension line of the second lateral cutting edge 241C and the second bottom cutting edge 251C, and the first clamping angle θ5 and the second clamping angle θ6 are between 75 and 90 degrees.

While we have shown and described various embodiments in accordance with the present invention, it is clear to those skilled in the art that further embodiments may be made without departing from the scope of the present invention.

What is claimed is:

1. A pair of single-blade-double-edged steel wire rope shears comprising: a first cutting member and a second cutting member pivotally connected to each other by a pivot member, characterized in that:
the first cutting member includes a first grip and a first blade, the first blade is provided at one side of the first cutting member facing the second cutting member with a first cutting portion, the first cutting portion includes a first lateral cutting surface, a first lateral cutting edge, a first bottom cutting surface, and a first bottom cutting edge, the first bottom cutting edge is connected to the first bottom cutting surface, the first bottom cutting surface is inclined, the first lateral cutting edge is connected to the first lateral cutting surface, and the first lateral cutting surface is inclined;
the second cutting member includes a second grip and a second blade, the second blade is provided at one side of the second cutting member facing the first cutting member with a second cutting portion, the second cutting portion includes a second lateral cutting surface, a second lateral cutting edge, a second bottom cutting surface and a second bottom cutting edge, the second bottom cutting surface is inclined and connected to the second bottom cutting edge, the second lateral cutting edge is connected to the second lateral cutting surface, and the second lateral cutting surface is inclined;
a first angle is defined between the first lateral cutting edge and the first bottom cutting edge, a second angle is defined between the second lateral cutting edge and the second bottom cutting edge, and the first and second angles are between 75 and 90 degrees;
when the first and second grips pivot toward each other, the first lateral cutting edge and the second lateral cutting edge cut a to-be-cut object which is inserted between the first and second lateral cutting edges, meanwhile, the first bottom cutting edge and the second bottom cutting edge also cut the to-be-cut object.

2. The pair of single-blade-double-edged steel wire rope shears as claimed in claim 1, wherein one surface of the first blade connected to the first bottom cutting edge is defined as a first lateral surface, one surface of the second blade connected to the second bottom cutting edge is defined as a second lateral surface, both the first lateral surface and the second lateral surface extend along the extending direction of an axis of the pivot member, an angle between the first lateral surface and the first bottom cutting surface is defined as a first inclination angle, an angle between the second lateral surface and the second bottom cutting surface is defined as a second inclination angle, and the first and second inclination angles are less than 90 degrees.

3. The pair of single-blade-double-edged steel wire rope shears as claimed in claim 2, wherein the first and second inclination angles are 75 to 89 degrees.

4. The pair of single-blade-double-edged steel wire rope shears as claimed in claim 2 further comprises a transverse direction, the first bottom cutting edge extends along the transverse direction, a surface of the first blade connected to the first lateral cutting edge is defined as a third lateral surface, a surface of the second blade connected to the second lateral cutting edge is defined as a fourth lateral surface, the third lateral surface and the fourth lateral surface all extend along the transverse direction, an angle defined between the third lateral surface and the first lateral cutting surface is defined as a third inclination angle, an angle between the fourth lateral surface and the second lateral cutting surface is defined as a fourth inclination angle, and the third and fourth inclination angles are less than 90 degrees.

5. The pair of single-blade-double-edged steel wire rope shears as claimed in claim 4, wherein the third and fourth inclination angles are 75 to 89 degrees.

6. The pair of single-blade-double-edged steel wire rope shears as claimed in claim 1, wherein the first bottom cutting edge extends along a transverse direction which is perpendicular to an axis of the pivot member, and when the first and second cutting members are opened, the axis separates the first lateral cutting edge and the second lateral cutting edge from each other at two different sides of a plane defined by the transverse direction and the axis.

7. The pair of single-blade-double-edged steel wire rope shears as claimed in claim 1, wherein the first bottom cutting edge extends along a transverse direction which is perpendicular to an axis of the pivot member, and when the first and second cutting members are opened, the axis makes the first lateral cutting edge and the second lateral cutting edge located at a same side of a plane defined by along the transverse direction and the axis.

8. The pair of single-blade-double-edged steel wire rope shears as claimed in claim 1, wherein the first lateral cutting surface is disconnected from the first bottom cutting surface, the second lateral cutting surface is disconnected from the second bottom cutting surface, the first lateral cutting edge is disconnected from the first bottom cutting edge, and the second lateral cutting edge is disconnected from the second bottom cutting edge.

9. The pair of single-blade-double-edged steel wire rope shears as claimed in claim 8, wherein a groove is defined between the first lateral cutting surface and the first bottom cutting surface, the groove is also defined between the first lateral cutting edge and the first bottom cutting edge, and a groove is defined between the second lateral cutting surface and the second bottom cutting surface, the groove is also defined between the second lateral cutting edge and the second bottom cutting edge.

10. The pair of single-blade-double-edged steel wire rope shears as claimed in claim 9, wherein a first clamping angle is defined between an imaginary extension line of the first lateral cutting edge and an imaginary extension line of the first bottom cutting edge, and a second clamping angle defined between an imaginary extension line of the second lateral cutting edge and the second bottom cutting edge, and the first clamping angle and the second clamping angle are between 75 and 90 degrees.

11. The pair of single-blade-double-edged steel wire rope shears as claimed in claim 1, wherein when the first lateral cutting surface moves away from the second lateral cutting surface to reach a maximum width, a combined length of the first and second bottom cutting edges is equal to or smaller than a distance between the first and second lateral cutting surfaces.
